(19) United States
(12) Patent Application Publication
(10) Pub. No.: US 2022/0245217 A1
(43) Pub. Date: Aug. 4, 2022

(54) Adaptive Selection of Source Matrix Version for Matrix Multiply Operations

(71) Applicant: Oracle International Corporation, Redwood City, CA (US)

(72) Inventors: Alex Kogan, Needham, MA (US); David Dice, Foxboro, MA (US)

(21) Appl. No.: 17/586,629

(22) Filed: Jan. 27, 2022

Related U.S. Application Data
(60) Provisional application No. 63/143,726, filed on Jan. 29, 2021.

(51) Int. Cl. G06F 17/16

(52) U.S. Cl. CPC G06F 17/16

(57) ABSTRACT

Adaptive selection of source matrix version for matrix multiply operations may be performed. Different versions of a matrix used in a matrix multiply operation, such as a transposed matrix and non-transposed matrix, may be selected and used when a matrix multiply operation is performed. The selection may be based on a performance profile that is identified for the matrix multiply operation.

### RELATED APPLICATIONS

This application claims benefit of priority to U.S. Provisional Application Ser. No. 63/143,726, entitled “Adaptive Selection of Source Matrix Version for Matrix Multiply Operations,” filed Jan. 29, 2021, and which is incorporated herein by reference in its entirety.

### BACKGROUND

Data processing techniques may rely upon low-level common operations in order to perform various high-level operations. For example, machine learning techniques may perform a large number of computations using a low-level common operation, such as a matrix multiply operation, in order to generate high-level results, such as an inference. As similar data processing techniques continue to be deployed in various applications, time or other computational cost constraints may become a greater factor in determining where and how such techniques can be utilized.

### SUMMARY

Techniques for adaptive selection of source matrix version for matrix multiply operations are described. Different versions of a matrix used in a matrix multiply operation, such as a transposed matrix and non-transposed matrix, may be selected when a matrix multiply operation is performed. The selection may be based on a performance profile that is identified for the matrix multiply operation.

### BRIEF DESCRIPTION OF THE DRAWINGS

FIG. 1 is a series of matrix multiply operation performance charts, according to some embodiments.

FIGS. 2A-2C are performance tables for example machine learning models, according to some embodiments.

FIG. 3 is a logical block diagram illustrating a machine learning system and framework that implements adaptive matrix multiply operations as part of linear modules, according to some embodiments.

FIG. 4 is a flow diagram illustrating methods and techniques for adaptive selection of source matrix versions for matrix multiply operations, according to some embodiments.

FIG. 5 is a flow diagram illustrating methods and techniques generating a performance profile for adaptive selection of source matrix versions for matrix multiply operations, according to some embodiments.

FIG. 6 is a flow diagram illustrating methods and techniques for dynamically managing the number of versions of matrices retained for performing a matrix multiply operation, according to some embodiments.

FIG. 7 illustrates an example computing system, according to some embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (e.g., meaning having the potential to) rather than the mandatory sense (e.g. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Various techniques for adaptive selection of source matrix versions for matrix multiply operations are described herein. Matrix multiplication operations that multiply two different matrices (e.g., source matrix A and source matrix B) to generate a resulting matrix (A*B=C) may be performed in various different systems, services or applications. For example, various data processing techniques may rely upon large numbers of matrix multiplication operations to process large amounts of data with large numbers of values. Machine learning techniques, such as the training and application of machine learning models to generate an inference, are an example of one area in which a large number of matrix multiplication operations (sometimes referred to herein as “matmul” operations) are performed. In these and other systems, services, or applications that rely upon a large number of matrix multiplication operations, performance improvements to the matrix multiplication operation itself, as discussed in detail below, can significantly improve performance of the system, service, or application overall.

For example, the Transformer architecture for deep neural networks (DNNs) has advanced the field of Natural Language Processing (NLP) in machine learning. A Transformer architecture may, for example, utilize self-attention layers instead of recurrent layers for handling sequential input data. A large number of Transformer-based models have been proposed, achieving state-of-the-art, and often better-than-human, performance on many NLP tasks which, until recently, have been considered unrealistically difficult to solve. Bidirectional Encoder Representations from Transformers (BERT), Robustly optimized BERT (RoBERTa), A Lite BERT (ALBERT), and Transformer-XL are only a very few examples in the vast number of published transformer-based machine learning models. As of today, Transformer-based models, and BERT in particular, power many important Web services, such as search, translation and text classification.

The big premise of the Transformer-based models is that they can be pre-trained on huge amounts of unlabeled data (such as all of large online data sources, such as Wikipedia or a book corpus), and later fine-tuned to a specific task (e.g., question-answering) using just a small amount of labeled, domain-specific data. To achieve high accuracy, those models feature millions (and, at times, billions) of parameters, and require long and expensive training. As a result, numerous efforts have been made to optimize the training performance of those models. At the same time, and despite the vast deployment of those models in practice, far less attention is paid to inference performance, utilizing the training of these models. Furthermore, among the efforts that do target inference performance of Transformer-based models, many consider Graphics Processing Unit (GPU) or smartphone-based deployments, even though in many practical settings the inference is done on small Central Processing Unit (CPU)-based systems.

Techniques for adaptive selection of source matrix versions for matrix multiply operations can improve scalability and performance of inferencing using Transformer-based models on CPUs and/or other processing hardware, such as GPUs, and Tensor Processing Units (TPUs). In various embodiments, adaptive selection of source matrix versions for matrix multiply operations may be based on the observation that the performance of the matrix multiply operations (sometimes referred to as “matmul”) is heavily impacted not only by the shape (dimensions) of the source matrices and the available computing resources (the number of worker threads) but also by whether (at least) one of those matrices is provided in a transposed form. Adaptive selection of source matrix versions for matrix multiply operations may choose the appropriate form of source matrices during the inference, which results in substantial performance improvement.

Consider, for instance, that the Transformer architecture may be composed of two stacks of identical layers; those stacks are called encoder and decoder. For the purpose of providing an example, this application discusses an encoder stack, which is used exclusively in many actual Transformer-based models, including BERT. BERT's model architecture is almost identical to the Transformer encoder, only tweaking the number of layers, the activation function, etc. Also, BERT itself has multiple configurations that differ in the various model hyper-parameters.

In some embodiments, each encoder layer (e.g., out of 12 in BERT) has two sublayers, the first being a multi-head self-attention mechanism and the second being a position-wise fully-connected feed-forward network. A residual connection is employed around each of the sub-layers, followed by layer normalization.

The attention mechanism is at the heart of the Transformer architecture. In various embodiments, the attention mechanism takes as an input three matrices Q, K and V and computes the output matrix:

$$Attn ( Q , K , V ) = softmax ( \frac{Q {K}^{T}}{\sqrt{{d}_{k}}} ) V$$

where dₖ is the attention input dimension (e.g., 64 for the BERT model).

As mentioned above, each self-attention sublayer includes multiple heads (e.g., 12 for the BERT model). The computed function of this sublayer is given by the following expressions:

MultiHead(Q,K,V)=Concat(head₁, . . . ,headₕ)W^{O}

where headᵢ=Attn(QWᵢ^{Q}, KWᵢ^{K},VWᵢ^{v}) where QWᵢ^{Q}, KWᵢ^{K}, and VWᵢ^{v} are parameter matrices.

Overall, the computation of the multi-head self-attention uses 4 matrix multiplications to create input token projections (the Q, K and V matrices) and the projection of the concatenated output of all the multiple heads. It should be noted that when Transformer is implemented in framework like Pytorch, each of those multiplications are performed during the computation of the corresponding Linear modules. In addition, two batched matrix multiplications are required to calculate the Attn function above. Furthermore, the self-attention sub-layer includes the invocation of softmax and layer normalization operations.

As for the fully-connected feed-forward sublayer, it consists of two linear transformations with an activation function in between:

FFN(x)=Act(xW₁+b₁)W₂+b₂

where W₁, b₁, W₂ and b₂ are weight and bias matrices, respectively (which are model parameters, one set for each layer) and Act is an activation function, such as gelu. While the inputs and outputs of the feed-forward sublayer have the same dimensions as the rest of the model (768, in case of BERT), the inner-layer has a larger dimensionality (3072 for BERT). It is easy to see that the computation of the feed-forward sublayer requires two matrix multiplication operations (carried by two Linear modules in Pytorch), as well as an activation function and a layer normalization operation

An examination of time spent performing inferences may be performed. In many scenarios, a vast majority of the inference time is spent in a linear module, which in practice means matmul operations (as the Linear module applies a linear transformation to the incoming data, calculating a product of the input matrix with the stored weight matrix). Therefore, in the example machine learning scenarios discussed above, an improvement in inference performance of a machine learning model may be achieved by reducing the time spent in matmul operations.

For example, the API for a matmul operation allows invoking that operation on two source matrices A and B (producing the destination matrix C=AB) In various embodiments, each of the source matrices can be provided in the transposed form. At the same time, a linear module may store the weight matrix in a transposed form, which means that, during inference, the input matrix (A) is always non-transposed, while the weight matrix (B) is always transposed.

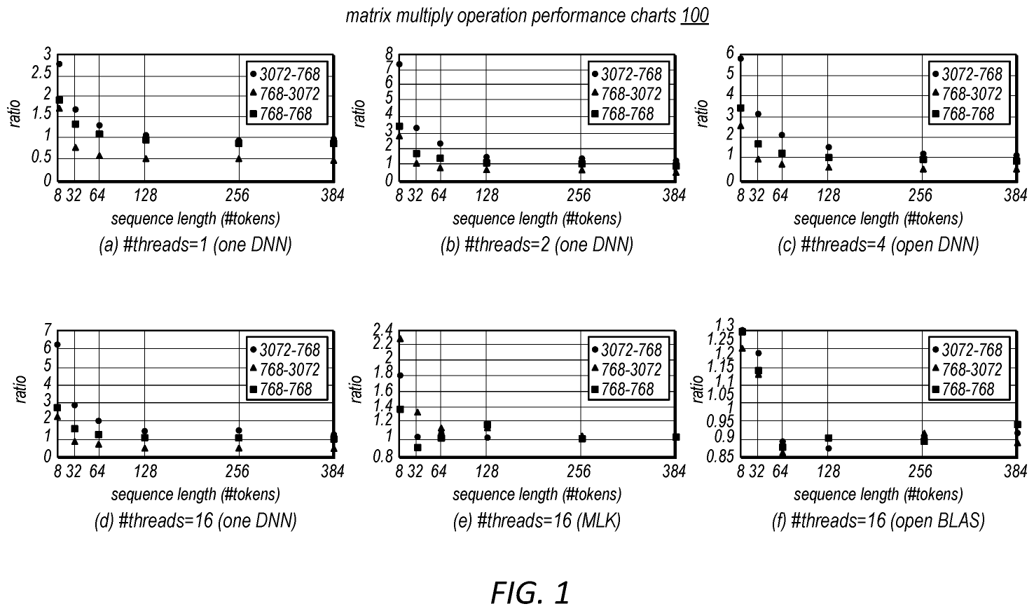

FIG. 1 is a series of matrix multiply operation performance charts, according to some embodiments. Matrix multiply operation performance charts 100 demonstrates the ratio between the time to compute matmul when both source matrices are non-transposed to the time to compute matmul when (only) the second source matrix is transposed. In other words, ratio >1 (ratio <1) corresponds to cases in which the former (latter, respectively) method is faster. The shape of the second matrix (B) is represented by the name of the corresponding data series, while the shape of the first matrix (A) is given by the sequence length x first dimension of B. Note that the chosen three shapes are not incidental, and they correspond to the shapes of weight matrices used in Linear modules of the BERT model.

Specifically, charts (a)-(d) in FIG. 1 compare the performance of the matmul operation using an example deep learning library (e.g., oneDNN) across different numbers of threads. For shorter sequences, multiplying the non-transposed matrices is almost always faster, and often results in substantial speedups. For longer sequences, the picture is less clear—one way of applying a matmul operation is faster than the other for one shape but worse for another. In general, the faster way of applying a matmul operation depends on the shape of the source matrices and the number of threads used. This observation is not unique to oneDNN, and is reproducible using other libraries. For example, charts (e) and (f) show the results obtained with MKL and OpenBLAS libraries, respectively.

In oneDNN, the matmul operation is JIT (just-in-time) compiled, and each of the matmul variants results in a different code path, which generates different memory access patterns. Based on the profiling information produced by perf, it may be observed that given a certain configuration (e.g., the same source matrix shapes and the number of threads), both variants have a similar number of L1 data cache misses, but the faster variant has a lower number of L3 cache accesses. This suggests that one reason for performance difference might be the better utilization of L2 cache by one variant over the other.

In view of the results in FIG. 1, in various embodiments, a linear module may implement adaptive selection of source matrix versions (e.g., between a transposed and non-transposed version of the weights matrix). For example, the linear module may be augmented with an array of values that specify which version of a matrix to use. In some embodiments, a transposeFlags array may be implemented, specifying whether to use a transposed version of the weights matrix for the forward pass (inference). Entry i of the array may correspond to the sequence length of 2ⁱ; In some embodiments, the array has 10 entries corresponding to the maximal length of 512 tokens. When creating a Linear module with the given weights shape [in,out], random matrices may be generated with the shape [2ⁱ,in], for each 0≤i<10, and measure the time to perform a matmul operation when the weight matrix is transposed or not. Based on the result, the corresponding entry transposeFlags[i] may be set. During the inference time, given the input of shape, s=[log (length)] and based on the flag in transposeFlags[s], perform the matmul operation with either weight matrix transposed or not.

To avoid the overhead of transposing the weight matrix during inference, both variants of the weight matrix (transposed and non-transposed one), in some embodiments. In other embodiments, other techniques for storing, generating, or otherwise obtaining the version of the weights may be implemented. For example, some shapes always prefer one form over the other, for all thread counts (e.g., the shape 3072-768 in FIG. 1). For this case, only the relevant version of the weight matrix may be stored. In some embodiments, the length of the input can be known prior to the deployment of an inference server for the machine learning model, e.g., in a farm of inference servers, certain servers can be configured to handle input of a certain sequence length. In this case, the relevant version of the weight matrix may be stored. In some embodiments, if the input range is dynamic, one can store one version of the weight matrix and transpose on-demand (e.g., if needed). The selection of the stored version can be also dynamic and tuned based on the actual input lengths seen during the runtime, in some embodiments.

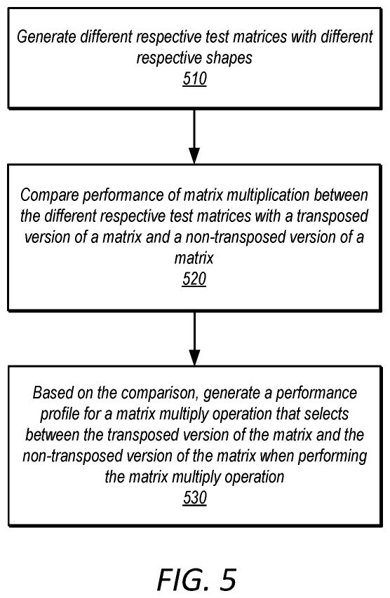

The transposeFlags array can be shared among Linear modules of the same shape. For example, a key-value map (dictionary) or other index may be used to store transposeFlags arrays where the [in, out] tuple of corresponding Linear modules serves as a key. Thus, when initializing the transposeFlags array, the dictionary may be accessed first, and if such a shape has been already profiled, the resulting array may be reused, skipping a profiling phase for that Linear module (as discussed above and below with regard to FIG. 5). For example, for the (base) BERT model, this optimization allows to reduce the number of profiling phases from 73 (6 Linear modules per each of the 12 self-attention layers plus one for the input embedding) to 3 (one per each different shape). In various embodiments, the profiling is run only once, during the initialization of the model (and its corresponding Linear modules), and is not invoked during inference.

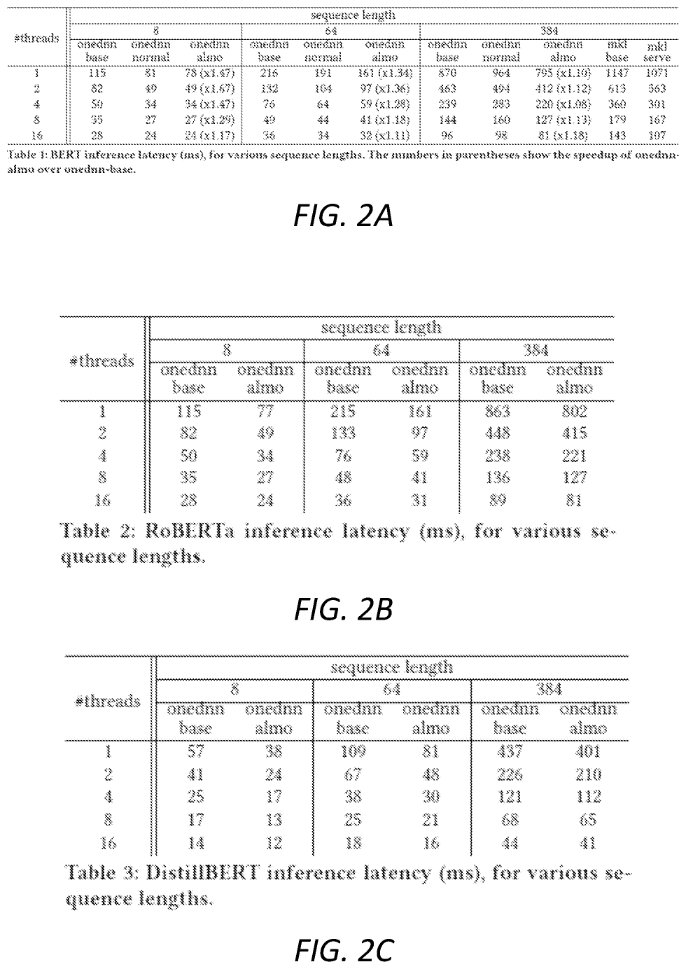

In FIG. 2A, Table 1 compares the performance of a HuggingFace inference benchmark run on top of several Pytorch variants, as follows: mkl-base is the Pytorch version installed from pip (and uses MKL math library), mkl-serve is the base version run in the torchscript mode (which creates “a serializable and optimizable models from PyTorch code” and therefore is a recommended mode for inference), onednn-base is the Pytorch version built from sources and uses oneDNN, onednn-normal is the onednn-base version in which the weight matrix is stored in a normal (non-transposed) shape, and onednn-almo is the onednn-base version with the adaptive Linear module optimization. It may be noted that the first two variants are included for reference only, to demonstrate that they perform mostly on-par or worse than onednn-base. Thus, they are included for one case only, for brevity. It may also be noted that the torchscript mode is not available yet for tensors in the oneDNN format, hence it is not applied with oneDNN-based variants.

Improvements in inference latency achieved by the adaptive Linear module optimization, as can be seen in Table 1, correlate strongly with the results in FIG. 1. Specifically, higher speedups are achieved on shorter sequences and fewer number of threads, which may be the settings where the ratios depicted in FIG. 1 are the highest. Adaptivity is beneficial for performance is also depicted. For example, while onednn-normal performs well on shorter sequences, its performance suffers on longer ones, which may be the settings in which, according to FIG. 1, multiplying the transposed weight matrix is faster. The adaptive variant selects the correct shape in each case, performing on-par or better than the other two oneDNN-based variants.

These improvements implementing various embodiments of the described techniques of adaptively selecting source matrix versions for matrix multiply operations extend to other Transformer-based models, as well as other machine learning systems or other systems, services or applications that rely upon performing large numbers of matrix multiply operations. For instance, Tables 2 and 3 in FIGS. 2B and 2C present the results for RoBERTa and DistillBERT transformer-based models respectively, in their “base” configurations.

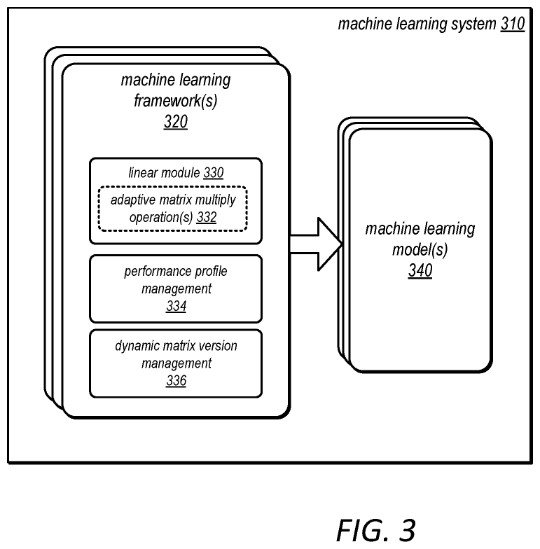

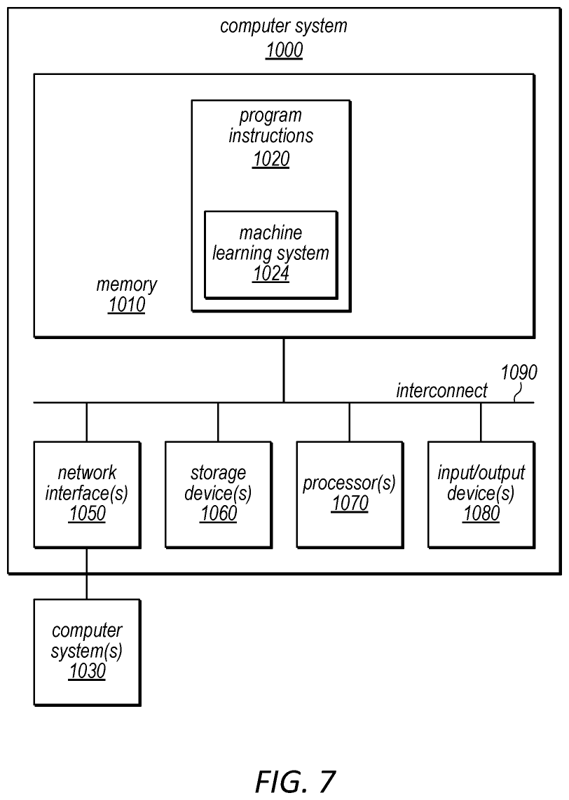

FIG. 3 is a logical block diagram illustrating a machine learning system and framework that implements adaptive matrix multiply operations as part of linear modules, according to some embodiments. A machine learning system 310 may support, utilize, or perform various machine learning techniques using one or multiple different machine learning framework(s) 320. Machine learning system 310 may be implemented in various ways utilizing one or multiple computing systems, such as those discussed below with regard to computer system 1000 in FIG. 7. In some embodiments, machine learning system 310 may be a standalone system or device (e.g., a mobile device that implements a machine learning model that performs matrix multiply operations to execute an application). In some embodiments, machine learning system 310 may be implemented as part of a network-based service (e.g. a Cloud-based service, Web service, etc.) where client systems may communicate with one or multiple computing systems (e.g., a fleet of computing systems, such as the server farm mentioned earlier), which may implement adaptive matrix multiple operations to improve inference performance. In various embodiments, machine learning system 310 may implement various types of processing hardware, including CPUs, GPUs, Tensor Processing Units (TPUs), or various other hardware which may perform matrix multiply operations adaptively, as discussed above and below.

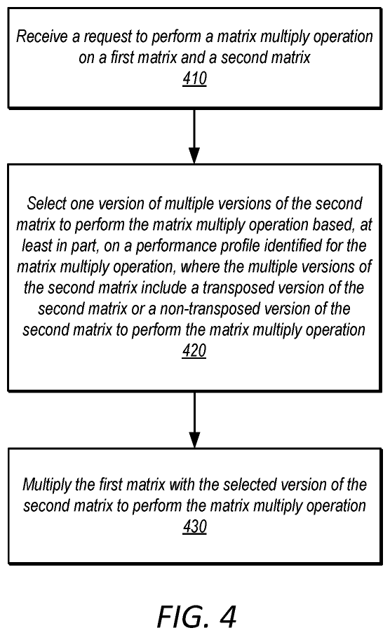

Machine learning frameworks 320 may support various interfaces, features, libraries, or other software tools for specifying or invoking adaptive matrix multiply operations 332 (which like the “matmul” operations discussed above and below with regard to FIG. 4), may be implemented as part of different machine learning model(s) 340. For example, linear module 330 (as discussed above) may implement adaptive matrix multiply operation(s) 332 as part of generating inferences when specified as part of machine learning model(s) 340.

In some embodiments, machine learning framework(s) 320 may also include optimizations for the performance of adaptive matrix multiply operation(s) 332. For example, performance profile management 334 may be implemented in various embodiments. Performance profile management 334 may implement techniques similar to those discussed below with regard to FIG. 5. Skipping or otherwise avoiding the generation of redundant performance profiles, for instance may be implemented.

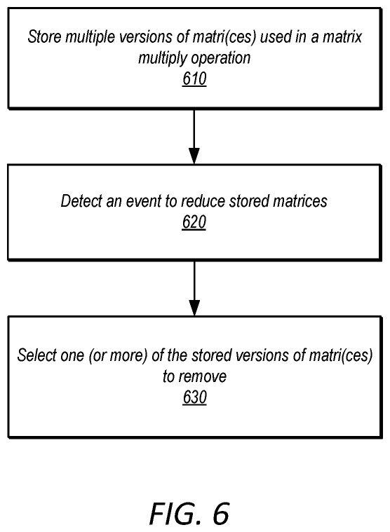

Another example of an optimization for the performance of adaptive matrix multiply operation(s) 332 may be dynamic matrix version management 336. As discussed below with regard to FIG. 6, an amount of storage used for stored versions of matrices may not always be efficient or available in different embodiments or operating scenarios. Therefore, dynamic matrix version management 336 may be able to dynamically remove the number of stored versions of matrices when different management events occur.

The various techniques discussed above may be implemented across a variety of different computing devices, including those discussed below with regard to FIG. 7. FIG. 4 is a flow diagram illustrating methods and techniques for adaptive selection of source matrix versions for matrix multiply operations, according to some embodiments. While the above examples of performing adaptive selection of source matrix versions for matrix multiply are given in the context of a machine learning system, like machine learning system 310, various other systems, services, or applications that perform matrix multiply operations may take advantage of the techniques described above, as well as those below, to improve the performance of matrix multiply operations across various types of processing devices (e.g., CPUs, GPUs, TPUs, etc.).

As indicated at 410, a request may be received to perform a matrix multiply operation on a first matrix and a second matrix, in some embodiments. For example, a “matmul” operation may be invoked as part of a linear module in a machine learning model. Other data processing systems, such as big data analytics applications or services, like data warehouses or other database systems, may also receive requests to perform a matrix multiply operation as part of supporting various features of the data processing system. In some embodiments, the first matrix may be an input matrix and the second matrix may be a weights matrix (although other scenarios that do not involve a weights matrix may also utilize the illustrated techniques).

As indicated at 420, a version out of a plurality of versions of the second matrix may be selected to perform the matrix multiply operation, in various embodiments. For example, the selection may be based on a performance profile identified for the matrix multiply operation. For example as discussed above, a transposeFlags array may be generated based on performance comparisons for a particular shape of weights array for a linear module. The input data, such as the first matrix or a portion thereof, may be used to generate an index value for the array to read the corresponding entry indicating whether a transposed version or a non-transposed version of the second matrix should be used. As noted above, some performance profiles may be shared. In this way, input data of the same shape may result in the generation of the same index value in order to identify and utilize a performance profile generated for another component (e.g., another linear module).

In various embodiments, one or multiple versions of the second matrix may be stored. For example, a transposed version may be stored and, in the event it is selected, a non-transposed version may be generated when a particular request to perform a matrix multiply operation that selects the non-transposed version is received. In some embodiments, the number of transposed versions may be dynamically managed (e.g., depending on available memory to store one or multiple versions, with a version being removed if other demands on the memory occur), as discussed in detail below with regard to FIG. 6. Thus, in various embodiments, a selected version may be dynamically generated for a matrix multiply operation, on-demand when a request to perform the matrix multiply operation is received. As indicated at 430, the first matrix may be multiplied with the second matrix to perform the matrix multiply operation, in some embodiments.

As discussed above with regard to FIGS. 1-2, various scenarios may occur in which one or another version of a source matrix would offer better performance. In at least some embodiments, profiling or other pre-execution analysis of matrix multiply operations (e.g., as part of differently shaped linear modules) may be performed in order to indicate (e.g., in the transposeFlags array) which version to use. FIG. 5 is a flow diagram illustrating methods and techniques generating a performance profile for adaptive selection of source matrix versions for matrix multiply operations, according to some embodiments.

As indicated at 510, different respective test matrices with different respective shapes may be generated, in some embodiments. For example, as discussed above, different token lengths may be compared with randomized input data at corresponding lengths for a test matrix. As indicated at 520, performance of matrix multiplication between the different respective test matrices with a transposed version of a matrix (e.g., the weights matrix or other “second matrix” discussed above with regard to FIG. 4) and the non-transposed version of the matrix may be compared. For example, a profiling run may perform both types of matrix multiplication on each test matrix.

As indicated at 530, a performance profile may be generated for a matrix multiply operation that selects between the transposed version of the matrix and the non-transposed version of the matrix when performing the matrix multiply operation may be generated, in some embodiments. For example, a threshold value (e.g., performance time less than X is for non-transposed and greater than/equal to X is for transposed) may be applied to sort between the different test matrix scenarios. The performance profile may, as discussed above, be represented as an array or other data structure that indicates the selection of a version according to a given input matrix (or portion thereof).

As discussed above, there may be some scenarios in which the generation of a performance profile may be avoided. For example, a performance profile may be shared between different components (e.g., Linear modules). Mapping or other indexing information that links performance profiles (e.g., transposeFlags arrays) to components. For components that can share a performance profile, only one iteration of the techniques described above to generate the performance profile may be performed.

The mapping or other indexing information may be used to determine when to skip or otherwise not generate a performance profile. For instance, shape information for a component, such as the [in, out] tuple of a Linear module, may be used to both identify components that can share a performance profile and be used to look up whether a performance profile has already been generated. During initialization of a machine learning model or other application that utilizes matrix multiplication, a lookup is performed when an initialization process encounters a component that utilizes matrix multiplication to determine whether profiling should be performed. Skipping redundant performance profile generation may increase speed and efficiency of initialization.

Similar to the techniques for efficient performance profile generation, techniques may be implemented that can improve the performance of a system that utilizes stored versions of matrices to select for matrix multiply operations. While the performance benefits of retaining and utilizing the more efficient version of a matrix for a matrix multiply operation can be great, there may be some scenarios where a balance between retaining versions of matrix multiply operations and freeing up storage resources (e.g., memory) for other uses may also be beneficial. FIG. 6 is a flow diagram illustrating methods and techniques for dynamically managing the number of versions of matrices retained for performing a matrix multiply operation, according to some embodiments.

As indicated at 610, multiple versions of matri(ces) used in a matrix multiply operation may be stored, in some embodiments. For example, matrix versions may be cached in a portion of memory when they are generated so that when they are used again, they can be obtained from memory instead of being regenerated. In some embodiments, the versions of matrices stored (e.g., transposed or not-transposed) may be generated and stored as part of initialization according to the version indicated by the performance profile for a component.

As indicated at 620, an event to reduce stored matri(ces) may be detected. For example, a machine learning framework or other application, program, library, or feature that utilizes adaptive selection of source matrix versions for matrix multiply may implement monitor or impose boundaries on the amount of memory or other storage that may be utilized for storing multiple versions of matri(ces). In this way, for embodiments that allow the number of stored versions of matrices to grow over time (e.g., the caching or other reuse techniques mentioned above) may be limited to an amount of storage, above which an event to reduce stored matrices may be detected (e.g., a number of stored matrices or amount of storage utilized by stored matrices). In some embodiments, the amount of storage available for storing versions of matrices may change over time. For example, various memory pressure or other storage monitoring features may be used to invoke events to reduce stored matrices as a result of the storage needs for other applications (or other portions of the application performing matrix multiply operations).

Responsive to or after the detected event, one (or more) of the stored versions of matri(ces) may be selected to remove, as indicated at 630. Different selection techniques may be employed. For example, in some embodiments, various caching techniques such as First In First Out (FIFO) or Last In First Out (LIFO) may be used. In some embodiments, selection techniques may rely upon the performance profile to determine the number of shapes of input data that correspond to a stored version (e.g., if most entries in a performance profile indicate that a non-transposed version of a matrix is used, then the transposed version of the may be selected). Once selected, the stored version of a matrix may be removed (e.g., deleted, marked for deletion, marked for overwrite, etc.).

When conditions change, such as reduction of memory or other storage pressure, then the number of stored versions of matrices may increase. In such scenarios, when additional versions of a matrix are generated (e.g., on-demand to perform a matrix multiply operation), then those additional versions of the matrix can be stored (even if they were previously removed).

FIG. 7 illustrates a computing system configured to implement the methods and techniques described herein, according to various embodiments. The computer system 1000 may be any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc., or in general any type of computing device.

The mechanisms for implementing adaptive selection of source matrix versions for matrix multiply, as described herein, may be provided as a computer program product, or software, that may include a non-transitory, computer-readable storage medium having stored thereon instructions, which may be used to program a computer system (or other electronic devices) to perform a process according to various embodiments. A non-transitory, computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

In various embodiments, computer system 1000 may include one or more processors 1070; each may include multiple cores, any of which may be single or multi-threaded. Each of the processors 1070 may include a hierarchy of caches, in various embodiments. The computer system 1000 may also include one or more persistent storage devices 1060 (e.g. optical storage, magnetic storage, hard drive, tape drive, solid state memory, etc.) and one or more system memories 1010 (e.g., one or more of cache, SRAM, DRAM, RDRAM, EDO RAM, DDR 10 RAM, SDRAM, Rambus RAM, EEPROM, etc.).

Various embodiments may include fewer or additional components not illustrated in FIG. 6 (e.g., video cards, audio cards, additional network interfaces, peripheral devices, a network interface such as an ATM interface, an Ethernet interface, a Frame Relay interface, etc.)

The one or more processors 1070, the storage device(s) 1050, and the system memory 1010 may be coupled to the system interconnect 1040. One or more of the system memories 1010 may contain program instructions 1020. Program instructions 1020 may be executable to implement various features described above, including a machine learning system 1024 or other system that utilizes matrix multiply operations as discussed above, in some embodiments as described herein. Program instructions 1020 may be encoded in platform native binary, any interpreted language such as Java™ byte-code, or in any other language such as C/C++, Java™, etc. or in any combination thereof. System memories 1010 may also contain LRU queue(s) 1026 upon which concurrent remove and add-to-front operations may be performed, in some embodiments.

In one embodiment, Interconnect 1090 may be configured to coordinate I/O traffic between processors 1070, storage devices 1070, and any peripheral devices in the device, including network interfaces 1050 or other peripheral interfaces, such as input/output devices 1080. In some embodiments, Interconnect 1090 may perform any necessary protocol, timing or other data transformations to convert data signals from one component (e.g., system memory 1010) into a format suitable for use by another component (e.g., processor 1070). In some embodiments, Interconnect 1090 may include support for devices attached through various types of peripheral buses, such as a variant of the Peripheral Component Interconnect (PCI) bus standard or the Universal Serial Bus (USB) standard, for example. In some embodiments, the function of Interconnect 1090 may be split into two or more separate components, such as a north bridge and a south bridge, for example. In addition, in some embodiments some or all of the functionality of Interconnect 1090, such as an interface to system memory 1010, may be incorporated directly into processor 1070.

Network interface 1050 may be configured to allow data to be exchanged between computer system 1000 and other devices attached to a network, such as other computer systems, or between nodes of computer system 1000. In various embodiments, network interface 1050 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1080 may, in some embodiments, include one or more display terminals, keyboards, keypads, touchpads, scanning devices, voice or optical recognition devices, or any other devices suitable for entering or retrieving data by one or more computer system 1000. Multiple input/output devices 1080 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1050.

Those skilled in the art will appreciate that computer system 1000 is merely illustrative and is not intended to limit the scope of the methods for providing enhanced accountability and trust in distributed ledgers as described herein. In particular, the computer system and devices may include any combination of hardware or software that may perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed:

1. A system, comprising:
at least one processor;
a memory, comprising program instructions that when executed by the at least one processor cause the at least one processor to implement a machine learning system, the machine learning system configured to:
responsive to a request to perform a matrix multiply operation on a first matrix and a second matrix:
select a version of a plurality of versions of the second matrix to perform the matrix multiply operation based, at least in part, on a performance profile identified for the matrix multiply operation, wherein the plurality of versions of the second matrix comprise a transposed version of the second matrix or a non-transposed version of the second matrix to perform the matrix multiply operation; and
multiply the first matrix with the selected version of the second matrix to perform the matrix multiply operation.

2. The system of claim 1, wherein the machine learning system is further configured to:
generate different respective test matrices with different respective shapes;
compare performance of matrix multiplication between the different respective test matrices with the different versions of the second matrix; and
based on the comparison, generate the performance profile for the matrix multiply operation.

3. The system of claim 1, wherein the machine learning system is further configured to:
responsive to the selection of the version of the second matrix:
generate the selected version of the matrix from another one of the plurality of versions of the second matrix.

4. The system of claim 1, wherein the plurality of versions of the second matrix are stored before performance of the matrix multiply operation, and wherein machine learning system is further configured to:
responsive to the selection of the version of the second matrix:
access the stored plurality of versions of the second matrix to obtain the selected version of the matrix.

5. The system of claim 1, wherein the performance profile is an array of values that respectively specify the version of the plurality of versions of the second matrix in different respective entries corresponding to different shapes of the first matrix and wherein to select the version of the plurality of versions of the second matrix to perform the matrix multiply operation, the machine learning system is configured to access one of the entries in the array of values identified according to a shape of the first matrix.

6. The system of claim 1, wherein the matrix multiply operation is performed as part of a linear module implemented as part of a machine learning model generating an inference and wherein the second matrix is a weight matrix.

7. A method, comprising:
performing, by one or more computing devices:
responsive to a request to perform a matrix multiply operation on a first matrix and a second matrix:
selecting a version of a plurality of versions of the second matrix to perform the matrix multiply operation based, at least in part, on a performance profile identified for the matrix multiply operation, wherein the plurality of versions of the second matrix comprise a transposed version of the second matrix or a non-transposed version of the second matrix to perform the matrix multiply operation; and
multiplying the first matrix with the selected version of the second matrix to perform the matrix multiply operation.

8. The method of claim 7, further comprising:
generating different respective test matrices with different respective shapes;
comparing performance of matrix multiplication between the different respective test matrices with the different versions of the second matrix; and
based on the comparison, generating the performance profile for the matrix multiply operation.

9. The method of claim 7, further comprising:
responsive to the selection of the version of the second matrix:
generating the selected version of the matrix from another one of the plurality of versions of the second matrix.

11. The method of claim 7, wherein the plurality of versions of the second matrix are stored before performance of the matrix multiply operation, and wherein the method further comprises:
responsive to the selection of the version of the second matrix:
accessing the stored plurality of versions of the second matrix to obtain the selected version of the matrix.

11. The method of claim 7, wherein the performance profile is an array of values that respectively specify the version of the plurality of versions of the second matrix in different respective entries corresponding to different shapes of the first matrix and wherein selecting the version of the plurality of versions of the second matrix to perform the matrix multiply operation comprises accessing one of the entries in the array of values identified according to a shape of the first matrix.

12. The method of claim 1, wherein the matrix multiply operation is performed as part of a linear module implemented as part of a machine learning model generating an inference and wherein the second matrix is a weight matrix.

13. The method of claim 7, wherein the plurality of versions of the second matrix are stored, and wherein the method further comprises:
detecting an event to reduce store matrices; and
responsive to detecting the event, selecting one or more of the plurality of versions of the second matrix to remove from storage.

14. One or more non-transitory, computer-readable storage media, storing program instructions that when executed on or across one or more computing devices, cause the one or more computing devices to implement:
responsive to a request to perform a matrix multiply operation on a first matrix and a second matrix:
selecting a version of a plurality of versions of the second matrix to perform the matrix multiply operation based, at least in part, on a performance profile identified for the matrix multiply operation, wherein the plurality of versions of the second matrix comprise a transposed version of the second matrix or a non-transposed version of the second matrix to perform the matrix multiply operation; and
multiplying the first matrix with the selected version of the second matrix to perform the matrix multiply operation.

15. The one or more non-transitory, computer-readable storage media of claim 14, storing additional program instructions that when executed on or across the one or more computing devices, cause the one or more computing devices to further implement:
generating different respective test matrices with different respective shapes;
comparing performance of matrix multiplication between the different respective test matrices with the different versions of the second matrix; and
based on the comparison, generating the performance profile for the matrix multiply operation.

16. The one or more non-transitory, computer-readable storage media of claim 14, storing additional program instructions that when executed on or across the one or more computing devices, cause the one or more computing devices to further implement:
responsive to the selection of the version of the second matrix:
generating the selected version of the matrix from another one of the plurality of versions of the second matrix.

17. The one or more non-transitory, computer-readable storage media of claim 14, wherein the plurality of versions of the second matrix are stored before performance of the matrix multiply operation, and wherein the one or more non-transitory, computer-readable storage media store additional program instructions that when executed on or across the one or more computing devices, cause the one or more computing devices to further implement:
responsive to the selection of the version of the second matrix:
accessing the stored plurality of versions of the second matrix to obtain the selected version of the matrix.

18. The system of claim 1, wherein the performance profile is an array of values that respectively specify the version of the plurality of versions of the second matrix in different respective entries corresponding to different shapes of the first matrix and wherein, in selecting the version of the plurality of versions of the second matrix to perform the matrix multiply operation, the program instructions cause the one or more processor to implement accessing one of the entries in the array of values identified according to a shape of the first matrix.

19. The system of claim 1, wherein the matrix multiply operation is performed as part of a linear module implemented as part of a machine learning model generating an inference and wherein the second matrix is a weight matrix.

20. The one or more non-transitory, computer-readable storage media of claim 14, wherein the plurality of versions of the second matrix are stored, and wherein the one or more non-transitory, computer-readable storage media store additional program instructions that when executed on or across the one or more computing devices, cause the one or more computing devices to further implement:
detecting an event to reduce store matrices; and
responsive to detecting the event, selecting one or more of the plurality of versions of the second matrix to remove from storage.
